(19) United States
(12) Patent Application Publication
(10) Pub. No.: US 2017/0118415 A1
(43) Pub. Date: Apr. 27, 2017

(54) TRACKING SHOOTING METHOD, MOBILE TERMINAL AND SYSTEM

(71) Applicants: LE HOLDINGS (BEIJING) CO., LTD., Beijing (CN); Lemobile Information Technology (Beijing) Co., Ltd., Beijing (CN)

(72) Inventors: Feng GAO, Beijing (CN); Shunhua LIU, Beijing (CN)

(21) Appl. No.: 15/236,310

(22) Filed: Aug. 12, 2016

Related U.S. Application Data
(63) Continuation of application No. PCT/CN2016/087024, filed on Jun. 24, 2016.

(30) Foreign Application Priority Data
Oct. 22, 2015 (CN) 201510691058.X

(51) Int. Cl. H04N 5/232; H04N 5/14

(52) U.S. Cl. CPC H04N 5/23296; H04N 5/145; H04N 5/23203

(57) ABSTRACT

Embodiments of the present disclosure disclose a tracking shooting method, a mobile terminal and a system. The method comprises: the mobile terminal receives a signal of activating a tracking shooting mode; an object to be tracked for shooting is selected in a shooting interface according to the signal; when the object to be tracked for shooting moves in a shooting picture, a movement vector of the object to be tracked for shooting is determined; the movement vector is sent to a pan-tilt that clamps the mobile terminal, such that the pan-tilt drives the mobile terminal to move according to the movement vector and the object to be tracked for shooting is remained in a shooting interface. By the present disclosure, automatic tracking shooting of the object to be tracked for shooting is realized and the object to be tracked for shooting is prevented from shifting out of the picture.

### CROSS-REFERENCE TO RELATED APPLICATIONS

The present disclosure is a continuation of International Application No. PCT/CN2016/087024, filed on Jun. 24, 2016; which claims priority to Chinese Patent Application No. 201510691058.X, entitled “TRACKING SHOOTING METHOD, MOBILE TERMINAL AND SYSTEM”, filed on Oct. 22, 2015, the entire contents of all of which are incorporated herein by reference.

### FIELD OF TECHNOLOGY

The present disclosure generally relates to the technical field of optoelectronics, and in particular relates to a tracking shooting method, a mobile terminal and a system.

### BACKGROUND

With the development of electronic and optoelectronic technologies, not only are more and more mobile terminals integrated with cameras, but also a plurality of cameras can be integrated on one mobile terminal; for example, a mobile terminal is integrated with both a front-facing camera and a back-facing camera. With continuous improvement of the pixels of the cameras, the definition of the captured photographs may even rival that of photographs captured by a card camera and a single lens reflex.

Conventionally, one case that a user uses a mobile terminal for shooting is the user holds the mobile terminal by a hand(s) for shooting; another case is that the mobile terminal is fixed on a tripod for shooting. In the shooting process, a shooting object often moves, such as running, jumping, and walking. Hence, when the user holds the mobile terminal by the hand, the user needs to keep on walking to ensure that the shooting object is located within a shooting picture; when the mobile terminal is fixed on the tripod, the user needs to manually move the tripod to ensure that the shooting object is located in the shooting picture. On one hand, if the user cannot immediately move the mobile terminal for tracking shooting, the shooting object may move out of the picture; on the other hand, more of the user's physical strength may be consumed in the movement process, and the feeling of fatigue will be aggravated, leading to bad experience of the user.

In conclusion, the problem to be solved for those skilled in the art is how to automatically move the mobile terminal to realize tracking shooting on the shooting object and remain the shooting object within the shooting picture.

### SUMMARY

Embodiments of the present disclosure disclose a tracking shooting method, a mobile terminal and a system, which are intended to solve the problem that a shooting object moves out of a picture because a user cannot immediately move a mobile terminal for tracking shooting in the prior art.

According to one aspect of the present disclosure, embodiments of the present disclosure disclose a tracking shooting method, which includes: at a mobile terminal, receiving a signal of activating a tracking shooting mode; selecting an object to be tracked for shooting in a shooting interface according to the signal;

determining a movement vector of the object to be tracked for shooting, when the object to be tracked for shooting moves in a shooting interface;

sending the determined movement vector to a pan-tilt that clamps the mobile terminal, such that the pan-tilt drives the mobile terminal to move according to the movement vector and remains the object to be tracked for shooting in the shooting interface.

Preferably, the movement vector includes a speed vector and a direction vector; and the pan-tilt drives the mobile terminal to move at the same speed vector and the same direction vector as the determined speed vector and the determined direction vector.

Preferably, the shooting interface comprises a preset tracking shooting region that is smaller than the shooting interface;

the operation of selecting the object to be tracked for shooting in the shooting interface according to the signal comprises: selecting the object to be tracked for shooting in the preset tracking shooting region of the shooting interface according to the signal:

the operation of remaining the object to be tracked for shooting in the shooting interface comprises: remaining the object to be tracked for shooting in the preset tracking shooting region of the shooting interface.

Preferably, the operation of sending the movement vector to the pan-tilt that clamps the mobile terminal comprises:

sending the movement vector to the pan-tilt that clamps the mobile terminal in any way of Bluetooth, infrared or USB.

Preferably, the object to be tracked for shooting includes human faces, clothes, or animals.

According to other aspect of the present disclosure, the embodiments of the present disclosure also disclose a mobile terminal for tracking shooting, including at least one processor; and a memory communicably connected with the at least one processor and for storing instructions executable by the at least one processor; wherein the at least one processor is configured to:

receive a signal of activating a tracking shooting mode;

select an object to be tracked for shooting in a shooting interface according to the signal;

determine a movement vector of the object to be tracked for shooting when the object to be tracked for shooting moves in the shooting interface;

send the determined movement vector to a pan-tilt that clamps the mobile terminal, such that the pan-tilt drives the mobile terminal to move according to the movement vector and remains the object to be tracked for shooting in the shooting interface.

Preferably, the determined movement vector comprises a determined speed vector and a determined direction vector; and the pan-tilt drives the mobile terminal to move at the same speed vector and the same direction vector as the determined speed vector and the direction vector.

Preferably, the shooting interface comprises a preset tracking shooting region that is smaller than the shooting interface;

and the at least one processor is further configured to select the object to be tracked for shooting in the preset tracking shooting region of the shooting interface according to the signal;

remain the object to be tracked for shooting in the preset tracking shooting region of the shooting interface.

Preferably, the at least one processor is further configured to send the movement vector to the pan-tilt that clamps the mobile terminal in any way of Bluetooth, infrared or USB.

Preferably, the object to be tracked for shooting includes human faces, clothes or animals.

According to another aspect of the present disclosure, the embodiments of the present disclosure also discloses a tracking shooting system, including the mobile terminal as mentioned in any above description, and a pan-tilt, wherein the pan-tilt includes a base; a receiver, a processor, and a first motor for driving a rotating rod to rotate are arranged in the base;

a second motor for driving a pitching rod to pitch is arranged at a top end of the rotating rod;

a clamp for clamping the mobile terminal is arranged at a top end of the pitching rod;

the receiver is configured to receive the movement vector sent by the mobile terminal and send the movement vector to the processor;

the processor is configured to receive the movement vector, generate a rotating signal and a pitching signal according to the movement vector, and send the rotating signal to the first motor and the pitching signal to the second motor;

the first motor is configured to drive the rotating rod to rotate horizontally according to the rotating signal by a rotating angle of 0-360 degrees;

the second motor is configured to drive the pitching rod to pitch at the top end of the rotating rod according to the pitching signal by a pitching angle of +/−60 degrees.

Preferably, the receiver includes a Bluetooth receiver, an infrared receiver and a USB interface.

According to yet another aspect of the present disclosure, provided is a computer program including computer readable codes, wherein when the computer readable codes run on the mobile terminal, leading to that the mobile terminal execute the above tracking shooting method.

According to further another aspect of the present disclosure, provided is a computer readable medium in which the above computer program is stored.

The present disclosure has the following beneficial effects:

according to the tracking shooting method, the mobile terminal and the system provided by the embodiments of the present disclosure, the signal of activating a tracking shooting mode is received by means of the mobile terminal; a object to be tracked for shooting is selected in a shooting interface according to the signal; when the object to be tracked for shooting moves in a shooting picture, a movement vector of the object to be tracked for shooting is determined; the movement vector is sent to a pan-tilt that clamps the mobile terminal, such that the pan-tilt drives the mobile terminal to move according to the movement vector and the object to be tracked for shooting is remained in a shooting interface; in such a way, automatic tracking shooting on the object to be tracked for shooting is realized, and the object to be tracked for shooting is prevented from moving out of a picture; in addition, the two hands of a user are liberated, and the user does not need to manually move the mobile terminal, and therefore, the experience of the user is enhanced.

The above descriptions are merely the summary of the technical solution of the present disclosure. In order to understand the technical means of the present disclosure more clearly, implementation can be carried out according to the contents of the description. Additionally, in order to make the above and other objectives, features and advantages of the present disclosure more obvious and understandable, specific embodiments of the present disclosure are described below.

### BRIEF DESCRIPTION OF THE DRAWINGS

In order to describe the embodiments of the present disclosure or technical solutions in the prior art more clearly, accompanying drawings needing to be used in the descriptions of the embodiments or the prior art will be introduced below briefly. It would be obvious that the accompanying drawings in the descriptions below are some embodiments of the present disclosure, and for a person ordinarily skilled in the art, other drawings may also be obtained according to the accompanying drawings without creative labor.

FIG. 1 is a step flow diagram of a tracking shooting method provided according to an embodiment of the present disclosure.

FIG. 2 is a structural schematic diagram of a mobile terminal capable of tracking shooting provided according to an embodiment of the present disclosure.

FIG. 3 is a structural schematic diagram of a tracking shooting system provided according to an embodiment of the pressure disclosure.

FIG. 4 exemplarily shows a block diagram of a mobile terminal for executing the method of the present disclosure.

FIG. 5 exemplarily shows a storage unit for holding or carrying program codes for implementing the method of the present disclosure.

### DESCRIPTION OF THE EMBODIMENTS

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Obviously, the described embodiments are part of embodiments of the present disclosure, not all embodiments. On the basis of the embodiments in the present disclosure, all the other embodiments obtained by people ordinarily skilled in the art without creative labor fall into the scope of protection of the present disclosure.

### First Embodiment

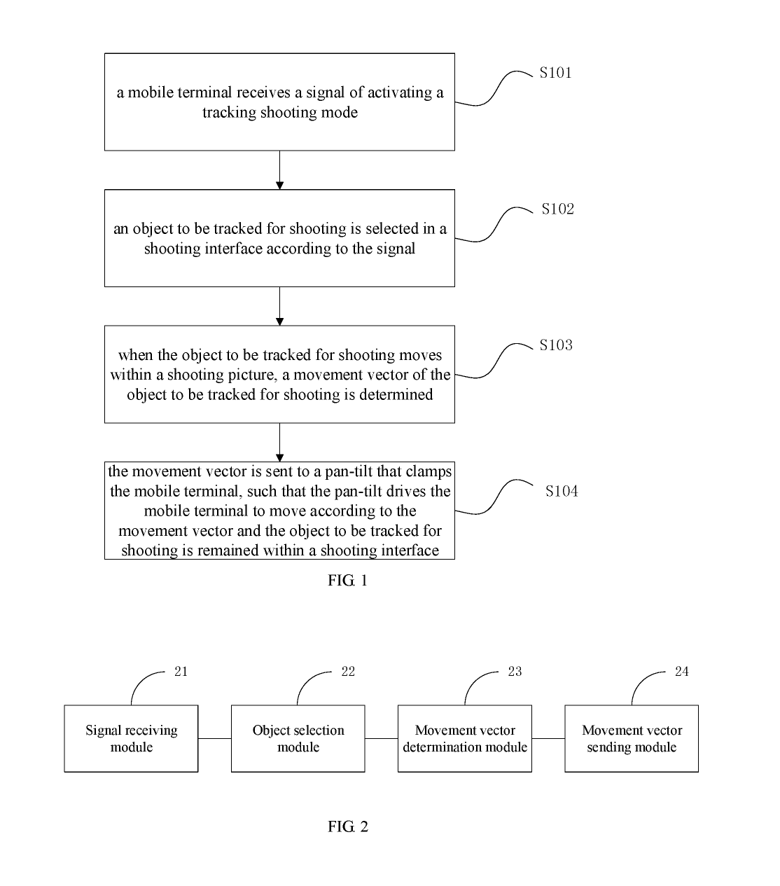

By referring to FIG. 1, illustrated is step flow diagram of a tracking shooting method provided according to an embodiment of the present disclosure.

In order to solve the problem that a shooting object moves out of a picture because a user cannot immediately move a mobile terminal for tracking shooting in the prior art, the present embodiment provides a tracking shooting method, which, as shown in FIG. 1, may include the following steps:

Step S101, a mobile terminal receives a signal of activating a tracking shooting mode.

In this step, the mobile terminal may include a mobile phone or a tablet computer with a camera. A user may activate a shooting application by triggering an icon or a virtual key of the shooting application displayed on the screen of the mobile terminal, and then the shooting interface may be displayed on the screen of the mobile terminal. A virtual key for activating the tracking shooting mode may be displayed on a shooting interface; the user triggers the virtual key for activating the tracking shooting mode, such that the mobile terminal may receive the signal of activating the tracking shooting mode.

Step S102, an object to be tracked for shooting is selected in a shooting interface according to the signal.

In this step, the mobile terminal may activate the tracking shooting mode of the shooting application according to the signal. The object to be tracked for shooting is an object in the shooting interface, and is a reference object for tracking shooting. There are many objects in the displayed shooting interface, in which some objects are moving, such as people and animals, while some objects stay still, such as furniture and walls. As the purpose for tracking shooting is to dynamically track the moving objects, the object to be tracked for shooting often is the moving object, such as a human face, clothes and an animal.

Step S103, when the object to be tracked for shooting moves within a shooting picture, a movement vector of the object to be tracked for shooting is determined.

In this step, the object to be tracked for shooting may move, e.g., run or jump, in the tracking shooting process, and when the object to be tracked for shooting moves within the shooting picture, the movement vector of the object to be tracked for shooting may be determined by measuring a movement speed and a movement direction of the object to be tracked for shooting within the shooting picture.

Step S104, the movement vector is sent to a pan-tilt that clamps the mobile terminal, such that the pan-tilt drives the mobile terminal to move according to the movement vector and the object to be tracked for shooting is remained within a shooting interface.

In this step, the mobile terminal may send the movement vector to the pan-tilt that clamps the mobile terminal in any way of Bluetooth, infrared, and USB (Universal Serial Bus). Accordingly, a Bluetooth receiver, an infrared receiver and/or a USB interface may be arranged in the pan-tilt to receive the movement vector.

According to the tracking shooting method provided according to this embodiment of the present disclosure, the signal for activating the tracking shooting mode is received by means of the mobile terminal; the object to be tracked for shooting is selected in the shooting interface according to the signal; when the object to be tracked for shooting moves within the shooting picture, the movement vector of the object to be tracked for shooting is determined; the movement vector is sent to the pan-tilt that clamps the mobile terminal, such that the pan-tilt drives the mobile terminal to move according to the movement vector and the object to be tracked for shooting is remained within the shooting interface; in such a way, automatic tracking shooting with respect to the object to be tracked for shooting is realized, and the object to be tracked for shooting is prevented from moving out of the picture; in addition, the two hands of the user are liberated, and the user does not need to manually move the mobile terminal, and therefore, the experience of the user is enhanced.

In a preferred embodiment of the present disclosure, the movement vector determined by the mobile terminal may include a speed vector and a director vector.

Thus, the step S104 may be optimized as follows: the speed vector and the direction vector are sent to the pan-tilt that clamps the mobile terminal such that the pan-tilt drives the mobile terminal to move at the same speed vector and the same direction vector according to the speed vector and the direction vector, leading to that the object to be tracked for shooting is remained within the shooting interface, and therefore, the accuracy of tracking shooting is improved.

In another preferred embodiment of the present disclosure, the shooting interface may include therein a preset tracking shooting region that is smaller than the shooting interface. The preset tracking shooting region may be automatically generated in a preset area at a preset position in the shooting interface; for example, the preset tracking shooting region is located at the central position of the shooting interface, accounting for 1/6 of the area of the shooting interface; it may also be defined manually by a user in the shooting interface; for example, the user manually draws a rectangular box as the preset tracking shooting region with a clicking point as a starting point and a lifting point as an end point on the shooting interface; of course, the preset tracking shooting region may also be a region in other shapes, such as a circle, an ellipse, or the like.

Thus, the above step S102 may be optimized to select the object to be tracked for shooting in the preset tracking shooting region of the shooting interface according to the signal.

Accordingly, the above step S104 may be optimized to: send the movement vector to the pan-tilt that clamps the mobile terminal such that the pan-tilt drives the mobile terminal to move according to the movement vector, thereby remaining the object to be tracked for shooting within the preset tracking shooting region of the shooting interface.

As more objects can be accommodated in the shooting interface, and less objects are accommodated in the preset tracking shooting region of the smaller area, the accuracy of selecting the object to be tracked for shooting is improved.

### Second Embodiment

By referring to FIG. 2, illustrated is a structural schematic diagram of a mobile terminal capable of tracking shooting provided according to an embodiment of the present disclosure.

The present embodiment provides the mobile terminal capable of tracking shooting, which is able to execute the tracking shooting method provided by the above embodiment; as shown in FIG. 2, the mobile terminal may include the modules of: a signal receiving module 21, an object selection module 22, a movement vector determination module 23, and a movement vector sending module 24.

In this embodiment of the present disclosure, the signal receiving module 21 is configured to receive a signal for activating a tracking shooting mode; the object selection module 22 is configured to select an object to be tracked for shooting in a shooting interface according to the signal; the movement vector determination module 23 is configured to determine a movement vector of the object to be tracked for shooting when the object to be tracked for shooting moves within a shooting picture; the movement vector sending module 24 is configured to send the movement vector to a pan-tilt that clamps the mobile terminal, such that the pan-tilt drives the mobile terminal to move according to the movement vector and the object to be tracked for shooting is remained within a shooting interface.

In the signal receiving module 21, a user may activate a shooting application by triggering an icon or a virtual key of the shooting application displayed on the screen of the mobile terminal, and then the shooting interface may be displayed on the screen of the mobile terminal. A virtual key for activating the tracking shooting mode may be displayed on a shooting interface; the user triggers the virtual key for activating the tracking shooting mode, such that the mobile terminal may receive the signal for activating the tracking shooting mode.

In the object selection module 22, the tracking shooting mode of the shooting application may be activated according to the signal. The object to be tracked for shooting is an object in the shooting interface, and is a reference object of tracking shooting. There are many objects in the displayed shooting interface, in which some objects are moving, such as people and animals, while some objects are stay still, such as furniture and walls. As the purpose for tracking shooting is to dynamically track the moving objects, the object to be tracked for shooting often is the moving object, such as a human face, clothes and an animal.

In the movement vector determination module 23, the object to be tracked for shooting may move, e.g., run or jump, in the tracking shooting process. When the object to be tracked for shooting moves within the shooting picture, the movement vector of the object to be tracked for shooting may be determined by measuring a movement speed and a movement direction of the object to be tracked for shooting within the shooting picture.

In the movement vector sending module 24, the movement vector may be sent to the pan-tilt that clamps the mobile terminal in any way of Bluetooth, infrared, and USB (Universal Serial Bus). Accordingly, a Bluetooth receiver, an infrared receiver and/or a USB interface may be arranged in the pan-tilt to receive the movement vector.

In the mobile terminal capable of tracking shooting provided according to this embodiment of the present disclosure, the signal for activating the tracking shooting mode is received by means of the mobile terminal; the object to be tracked for shooting is selected in the shooting interface according to the signal; when the object to be tracked for shooting moves within the shooting picture, the movement vector of the object to be tracked for shooting is determined; the movement vector is sent to the pan-tilt that clamps the mobile terminal, such that the pan-tilt drives the mobile terminal to move according to the movement vector and the object to be tracked for shooting is remained within the shooting interface; in such a way, automatic tracking shooting on the object to be tracked for shooting is realized, and the object to be tracked for shooting is prevented from moving out of the picture; in addition, the two hands of the user are liberated, and the user does not need to manually move the mobile terminal, and therefore, the experience of the user is enhanced.

In a mobile terminal of the preferred embodiment of the present disclosure, the movement vector may include a speed vector and a director vector.

Thus, the above movement vector sending module 44 is specifically configured to: send the speed vector and the direction vector to the pan-tilt that clamps the mobile terminal such that the pan-tilt drives the mobile terminal to move at the same speed vector and the same direction vector according to the speed vector and the direction vector, leading to that the object to be tracked for shooting is remained within the shooting interface, and therefore, the accuracy of tracking shooting is improved.

In the mobile terminal of another preferred embodiment of the present disclosure, the shooting interface may include therein a preset tracking shooting region that is smaller than the shooting interface. The preset tracking shooting region may be automatically generated in a preset area at a preset position in the shooting interface; for example, the preset tracking shooting region is located at the central position of the shooting interface, accounting for 1/6 of the area of the shooting interface; it may also be defined manually by a user in the shooting interface; for example, the user manually draws a rectangular box as the preset tracking shooting region with a clicking point as a starting point and a lifting point as an end point on the shooting interface; of course, the preset tracking shooting region may also be a region in other shapes, such as a circle, an ellipse, or the like.

Thus, the above target selection module 22 is specifically configured to select the object to be tracked for shooting in the preset tracking shooting region of the shooting interface according to the signal.

Thus, the above movement vector sending module 24 is specifically configured to send the movement vector to the pan-tilt that clamps the mobile terminal such that the pan-tilt drives the mobile terminal to move according to the movement vector, thereby remaining the object to be tracked for shooting within the preset tracking shooting region of the shooting interface.

As more objects can be accommodated in the shooting interface, and less objects are accommodated in the preset tracking shooting region of the smaller area, the accuracy of the object of selecting the tracking shooting is improved.

### Third Embodiment

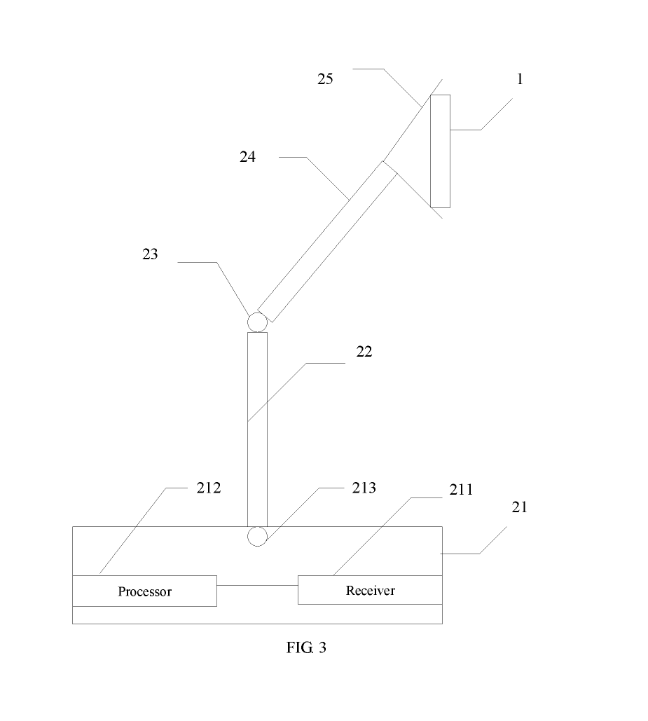

By referring to FIG. 3, illustrated is a structural schematic diagram of a tracking shooting system provided according to an embodiment of the pressure disclosure.

In order to realize the objective of tracking shooting, the present embodiment provides a tracking shooting system, which, as shown in FIG. 3, may include the following devices: the mobile terminal 1 provided according to the above embodiment, and a pan-tilt.

In this embodiment of the present disclosure, the pan-tilt may include: a base 21;

a receiver 211, a processor 212, and a first motor 213 for driving a rotating rod 22 to rotate are arranged in the base 21;

a second motor 23 for driving a pitching rod 24 to pitch is arranged at a top end of the rotating rod 22;

a clamp 25 for clamping the mobile terminal 1 is arranged at a top end of the pitching rod 24;

the receiver is configured to receive the movement vector sent by the mobile terminal and send the movement vector to the processor;

the processor 211 is configured to receive the movement vector, generate a rotating signal and a pitching signal according to the movement vector, and send the rotating signal to the first motor 213 and the pitching signal to the second motor 23;

the first motor 213 is configured to drive the rotating rod 22 to rotate horizontally according to the rotating signal by a rotating angle of 0-360 degrees;

the second motor 23 is configured to drive the pitching rod 24 to pitch at the top end of the rotating rod 22 according to the pitching signal by a pitching angle of +/−60 degrees.

The receiver in this embodiment of the present disclosure may include any one or more of a Bluetooth receiver, an infrared receiver, and a USB interface.

In the tracking shooting system provided according to this embodiment of the present disclosure, the mobile terminal receives the signal of activating the tracking shooting mode; the object to be tracked for shooting is selected in the shooting interface according to the signal; when the object to be tracked for shooting moves within the shooting picture, the movement vector of the object to be tracked for shooting is determined; the movement vector is sent to the pan-tilt that clamps the mobile terminal, such that the pan-tilt drives the mobile terminal to move according to the movement vector and the object to be tracked for shooting is remained within the shooting interface; in such a way, automatic tracking shooting on the object to be tracked for shooting is realized, and the object to be tracked for shooting is prevented from moving out of the picture; in addition, the two hands of the user are liberated, and the user does not need to manually move the mobile terminal, and therefore, the experience of the user is enhanced.

The device embodiment described above is merely exemplarily, wherein units described as separate parts may be or not separated physically, and parts displayed as units may be or not physical units, which may be located at the same place, or may also be distributed on a plurality of network units. Partial or all modules therein may be selected according to actual requirements to achieve the objectives of the solutions of the present embodiment. The solutions can be understood and implemented by a person ordinarily skilled in the art without creative labor.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

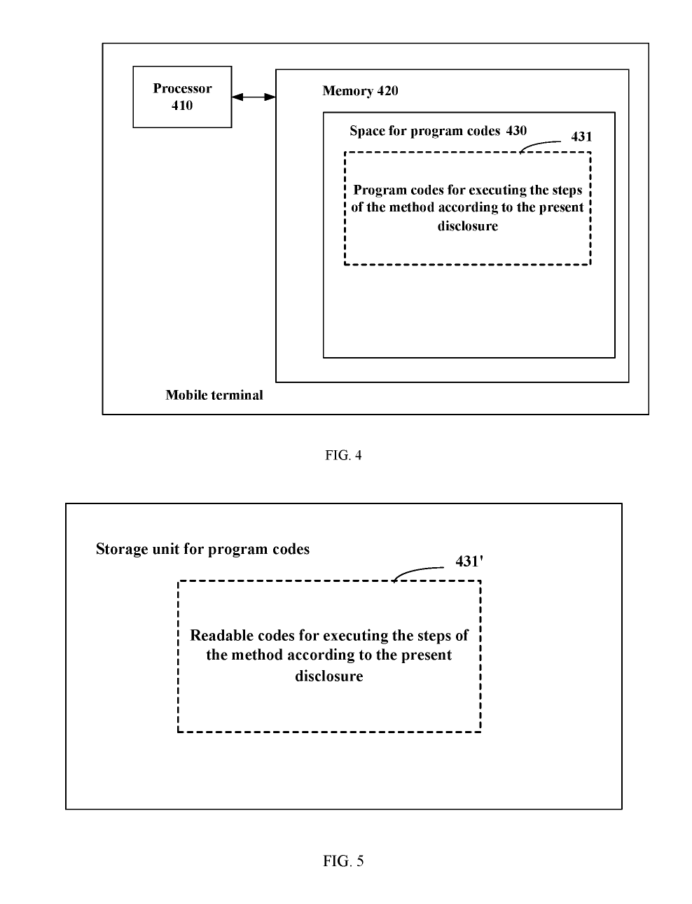

For example, FIG. 4 illustrates a block diagram of a mobile terminal for executing the method for tracking shooting according the disclosure, for example, an application mobile terminal. The mobile terminal includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the server as shown in FIG. 4. The program codes may be compressed for example in an appropriate form. Usually, the memory cell includes computer readable codes 431′ which can be read for example by processors 410. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

It should be noted at last that the above embodiments are merely intended to illustrate the technical solutions of the present disclosure, and not meant to limiting; although the present disclosure is described in detail with reference to the forgoing embodiments, it should be appreciated by a person ordinarily skilled in the art that the technical solutions described in each forgoing embodiment still can be modified, or partial technical features therein may be equivalently substituted; and these modifications or substitutions do not cause the nature of the corresponding technical solutions to depart from the concept and scope of the technical solutions in various embodiments of the present disclosure.

What is claimed is:

1. A tracking shooting method, comprising:
at a mobile terminal,
receiving a signal of activating a tracking shooting mode;
selecting an object to be tracked for shooting in a shooting interface according to the signal;
determining a movement vector of the object to be tracked for shooting, when the object to be tracked for shooting moves in a shooting interface;
sending the determined movement vector to a pan-tilt that clamps the mobile terminal, such that the pan-tilt drives the mobile terminal to move according to the movement vector and remains the object to be tracked for shooting in the shooting interface.

2. The method according to claim 1, wherein the determined movement vector comprises a determined speed vector and a determined direction vector, and the pan-tilt drives the mobile terminal to move at the same speed vector and the same direction vector as the determined speed vector and the determined direction vector.

3. The method according to claim 1, wherein the shooting interface comprises a preset tracking shooting region that is smaller than the shooting interface;
the operation of selecting the object to be tracked for shooting in the shooting interface according to the signal comprises: selecting the object to be tracked for shooting in the preset tracking shooting region of the shooting interface according to the signal;
the operation of remaining the object to be tracked for shooting in the shooting interface comprises: remaining the object to be tracked for shooting in the preset tracking shooting region of the shooting interface.

4. The method according to claim 1, wherein the operation of sending the movement vector to the pan-tilt that clamps the mobile terminal comprises:
sending the movement vector to the pan-tilt that clamps the mobile terminal in any way of Bluetooth, infrared or USB.

5. The method according to claim 1, wherein the object to be tracked for shooting includes human faces, clothes, or animals.

6. A mobile terminal for tracking shooting, comprising:
at least one processor; and
a memory communicably connected with the at least one processor and for storing instructions executable by the at least one processor,
wherein the at least one processor is configured to:
receive a signal of activating a tracking shooting mode;
select an object to be tracked for shooting in a shooting interface according to the signal;
determine a movement vector of the object to be tracked for shooting when the object to be tracked for shooting moves in the shooting interface;
send the determined movement vector to a pan-tilt that clamps the mobile terminal, such that the pan-tilt drives the mobile terminal to move according to the movement vector and remains the object to be tracked for shooting in the shooting interface.

7. The mobile terminal according to claim 6, wherein the determined movement vector comprises a determined speed vector and a determined direction vector;
and the pan-tilt drives the mobile terminal to move at the same speed vector and the same direction vector as the determined speed vector and the direction vector.

8. The mobile terminal according to claim 6, wherein the shooting interface comprises a preset tracking shooting region that is smaller than the shooting interface;
and the at least one processor is further configured to:
select the object to be tracked for shooting in the preset tracking shooting region of the shooting interface according to the signal;
remain the object to be tracked for shooting in the preset tracking shooting region of the shooting interface.

9. The mobile terminal according to claim 6, wherein the at least one processor is further configured to: send the movement vector to the pan-tilt that clamps the mobile terminal in any way of Bluetooth, infrared or USB.

10. The mobile terminal according to claim 6, wherein the object to be tracked for shooting includes human faces, clothes or animals.

11. A system for tracking shooting, comprising a pan-tilt and the mobile terminal according to claim 6, wherein:
the pan-tilt comprises a base;
a receiver, a first processor, and a first motor for driving a rotating rod to rotate are arranged in the base;
a second motor for driving a pitching rod to pitch is arranged at a top end of the rotating rod;
a clamp for clamping the mobile terminal is arranged at a top end of the pitching rod;
the receiver is configured to receive the movement vector sent by the mobile terminal and send the movement vector to the first processor;
the first processor is configured to receive the movement vector, generate a rotating signal and a pitching signal according to the movement vector, and send the rotating signal to the first motor and the pitching signal to the second motor;
the first motor is configured to drive the rotating rod to rotate horizontally according to the rotating signal by a rotating angle of 0-360 degrees;
the second motor is configured to drive the pitching rod to pitch at the top end of the rotating rod according to the pitching signal by a pitching angle of +/−60 degrees.

12. The system according to claim 11, wherein the receiver comprises a Bluetooth receiver, an infrared receiver or a USB interface.

13. The system according to claim 11, wherein the determined movement vector comprises a determined speed vector and a determined direction vector;
and the pan-tilt drives the mobile terminal to move at the same speed vector and the same direction vector as the determined speed vector and the direction vector.

14. The system according to claim 11, wherein the shooting interface comprises a preset tracking shooting region that is smaller than the shooting interface;
and the at least one processor of the mobile terminal is further configured to:
select the object to be tracked for shooting in the preset tracking shooting region of the shooting interface according to the signal;
remain the object to be tracked for shooting in the preset tracking shooting region of the shooting interface.

15. The system according to claim 11, wherein the at least one processor of the mobile terminal is further configured to: send the movement vector to the pan-tilt that clamps the mobile terminal in any way of Bluetooth, infrared or USB.

16. The system according to claim 11, wherein the object to be tracked for shooting includes human faces, clothes or animals.
